(19) United States
(12) Patent Application Publication
(10) Pub. No.: US 2012/0200769 A1
(43) Pub. Date: Aug. 9, 2012

(54) VIDEO SIGNAL PROCESSING APPARATUS, VIDEO SIGNAL PROCESSING METHOD, AND PROGRAM

(75) Inventor: Tomoichi Fujisawa, Kanagawa (JP)

(73) Assignee: Sony Corporation, Tokyo (JP)

(21) Appl. No.: 13/364,520

(22) Filed: Feb. 2, 2012

(30) Foreign Application Priority Data
Feb. 9, 2011 (JP) P2011-026545

(51) Int. Cl. H04N 7/26

(52) U.S. Cl. 348/420.1; 348/E07.001

(57) ABSTRACT

A video signal processing apparatus including: a video signal band measurement unit that measures a signal band of an input video signal; a band level evaluation unit that evaluates a band level of the resultant signal band measured by the video signal band measurement unit; a block size detection sensitivity adjustment unit that adjusts block size detection sensitivities in block size detection based on the band level evaluated by the band level evaluation unit; and a block size detection unit that detects the block sizes of blocks in the input video signal by using the block size detection sensitivities adjusted by the block size detection sensitivity adjustment unit.

### CROSS-REFERENCE TO RELATED APPLICATION

The present application claims priority from Japanese Patent Application No. JP 2011-026545 filed in the Japanese Patent Office on Feb. 9, 2011, the entire content of which is incorporated herein by reference.

### FIELD

The present disclosure relates to a video signal processing apparatus, a video signal processing method, and a program, and particularly to a video signal processing apparatus, method, and program that detects block sizes of a video signal and reduces the amount of block noise based on the block sizes.

### BACKGROUND

When an encoded video signal (image data) is decoded, it is known that the decoded video signal (image data) is accompanied by noise. For example, to compress a video signal (image data) by using an MPEG (moving picture experts group) method or any other compression method, an encoder divides the video signal (image data) into rectangular blocks each of which is formed of a plurality of pixels and performs DCT (discrete cosine transform) on each of the divided blocks.

As a result, when a decoder decodes the video signal (image data) encoded by using the MPEG method, the decoded video signal (image data) in principle suffers from a step in pixel value between the pixels along the block boundaries, often resulting in block noise.

An apparatus for reducing or removing such block noise typically does so by applying LPF (low-pass filtering) for smoothing to the pixels in the positions along the boundaries between the blocks having a known block size (8×8 pixels in MPEG2, for example). To perform the smoothing, it is necessary to provide in advance information on block size of inputted image data. For example, JP-A-2009-232367 describes a technology for detecting the block size of a video signal (image data).

### SUMMARY

The technology described in JP-A-2009-232367 allows a plurality of block sizes to be detected. However, depending on the characteristics of an input video signal, correct block sizes may not be detected in some cases. For example, when the technology described in JP-A-2009-232367 is used to detect the block sizes of an input video signal that are, for example, “8” and “10.66”, the detected block sizes may be “16” and “21.33” in some cases. When a correct block size is not detected, part of the blocks disadvantageously does not undergo block noise reduction.

The block noise reduction is performed by applying LPF for smoothing to the pixels along the block boundaries, as described above. As a result, when an input video signal is a high-definition video signal and undergoes the block noise reduction, blur or other video quality degradation may occur in some cases.

It is therefore desirable to detect block sizes in a precise manner. It is further desirable to reduce the amount of block noise effectively without degradation of a video signal in the block noise reduction.

An embodiment of the present disclosure is directed to a video signal processing apparatus including
a video signal band measurement unit that measures a signal band of an input video signal,
a band level evaluation unit that evaluates a band level of the resultant signal band measured by the video signal band measurement unit,
a block size detection sensitivity adjustment unit that adjusts block size detection sensitivities in block size detection based on the band level evaluated by the band level evaluation unit, and
a block size detection unit that detects the block sizes of blocks in the input video signal by using the block size detection sensitivities adjusted by the block size detection sensitivity adjustment unit.

In the embodiment of the present disclosure, the video signal band measurement unit measures the signal band of an input video signal. In this case, for example, the video signal band measurement unit not only performs filtering by which signal components of a predetermined number of bands are extracted from the input video signal but also provides a measured signal band of the input video signal based on the signal components of the predetermined number of bands. Further, in this case, for example, the video signal band measurement unit measures the signal band of the input video signal for each divided area obtained by dividing a screen into a predetermined number of areas.

The band level evaluation unit evaluates the band level based on the measured signal band measured by the video signal band measurement unit. In this case, for example, the band level evaluation unit evaluates the band level and relates the band level to one of a predetermined number of levels, for example, levels 1 to 10.

Further, in this case, for example, when the video signal band measurement unit measures the signal band of the input video signal for each divided area obtained by dividing the screen into a predetermined number of areas, the band level evaluation unit not only evaluates the band level for each of the divided areas based on the measured value of the divided area but also evaluates the band level of the entire screen based on all or part of the band levels evaluated for the divided areas.

In this process, it is allowed to evaluate the band level of the entire screen based on part of the band levels evaluated for the divided areas. In this way, the evaluation of the band level of the entire screen will not be affected, for example, by the band level of a divided area containing a black strip portion where substantially no video signal is present or the band level of a divided area in the periphery, for example, at a corner where the amount of important information on a video signal is small, whereby the band level of the entire screen can be evaluated more precisely.

Further, in this case, for example, band levels evaluated in the current frame and a predetermined number of past frames are averaged, and the average is used as a final evaluated band level. Averaging band levels evaluated not only in the current frame but also in a predetermined number of past frames prevents a final band level from varying due to partial change in a video signal and allows the final band level to be stably evaluated.

The block size detection sensitivity adjustment unit adjusts block size detection sensitivities in block size detection based on the band level evaluated by the band level evaluation unit. In this case, for example, the block size detection sensitivity adjustment unit performs the adjustment in such a way that the detection sensitivity to a small block size is set at a high value when the band level is high. The block size detection unit then detects the block sizes of blocks in the input video signal by using the block size detection sensitivities adjusted by the block size detection sensitivity adjustment unit.

In this case, for example, the block size detection unit includes a block step histogram acquisition section that determines whether or not there is a block step for each of a predetermined number of pixels based on the input video signal and creates a histogram of the results having been determined to be block steps, a histogram analysis section that performs sensitivity adjustment by multiplying measured values of each of the block sizes in the histogram acquired by the block step histogram acquisition section by an adjustment coefficient set in accordance with the detection sensitivity to the block size, and a block size evaluation section that multiplies the average of the measured values of each of the block sizes having undergone the sensitivity adjustment in the histogram analysis section by a correction coefficient set in accordance with the detection sensitivity to the block size and evaluates the block size based on the corrected block size.

As described above, in the embodiment of the present disclosure, the signal band of an input video signal is measured, and the band level is evaluated. The block size detection sensitivities are adjusted based on the evaluated band level, whereby the block sizes can be precisely detected.

Another embodiment of the present disclosure is directed to a video signal processing apparatus including
a block size detection unit that detects block sizes of blocks in an input video signal,
a block noise reduction unit that reduces the amount of block noise contained in the input video signal based on the block sizes detected by the block size detection unit,
a video signal band measurement unit that measures a signal band of the input video signal, and
a band level evaluation unit that evaluates a band level of the resultant signal band measured by the video signal band measurement unit.

A block noise reduction filter used in the block noise reduction unit is selected based on the band level evaluated by the band level evaluation unit.

In the embodiment of the present disclosure, the block size detection unit detects block sizes of blocks in an input video signal. The block noise reduction unit then reduces the amount of block noise contained in the input video signal based on the block sizes detected by the block size detection unit. In this case, for example, block noise reduction filtering (LPF) for smoothing is applied to the pixels in the positions along the boundaries between the blocks having the detected block sizes.

The video signal band measurement unit measures a signal band of the input video signal. The band level evaluation unit evaluates a band level of the resultant signal band measured by the video signal band measurement unit. A block noise reduction filter used in the block noise reduction unit is selected based on the evaluated band level. In this case, for example, when the band level is high, a block noise reduction filter having weakened low-pass filter characteristics is selected.

As described above, in the embodiment of the present disclosure, to reduce the amount of block noise based on the detected block sizes, an appropriate block noise reduction filter according to the evaluated band level is selected and used. As a result, the amount of block noise can be effectively reduced without any degradation of the video signal.

In the embodiment of the present disclosure, for example, a block size detection sensitivity adjustment unit that adjusts block size detection sensitivities in block size detection based on the band level evaluated by the band level evaluation unit may be further provided, and the block size detection unit may detect the block sizes of blocks in the input video signal by using the block size detection sensitivities adjusted by the block size detection sensitivity adjustment unit. The block sizes can therefore be precisely detected, whereby the amount of block noise can be more effectively reduced.

According to the embodiments of the present disclosure, block sizes can be detected in a precise manner. According to the embodiments of the present disclosure, the amount of block noise can also be effectively reduced without degradation of a video signal in the block noise reduction.

### BRIEF DESCRIPTION OF THE DRAWINGS

FIG. 1 is a block diagram showing an example of the configuration of a video signal processing apparatus as an embodiment of the present disclosure;

FIG. 2 shows an example of screen division in signal band measurement;

FIGS. 3A-3C show an example of filtering in the signal band measurement;

FIG. 4 is a flowchart showing an example of band level evaluation performed in a video signal band level evaluation unit;

FIG. 5 shows a case where a screen is divided into 16 areas for signal band measurement and divided areas at four corners are not used when the band level of the entire screen is determined;

FIG. 6 shows an example of the relationship between the band level and detection sensitivity referred to when block size detection sensitivity is adjusted;

FIG. 7 is a block diagram showing an example of the configuration of a block size detection unit that forms the video signal processing apparatus;

FIG. 8 shows an example in which a block step histogram acquisition section evaluates a block step for each pixel;

FIG. 9 shows an example of histogram data strings counted by the block step histogram acquisition section;

FIGS. 10A and 10B show examples in which the block step histogram acquisition section evaluates a block step for every two or three pixels;

FIG. 11 shows adjustment of measured values (measured values of block size of 8) performed in a histogram analysis section;

FIG. 12 shows adjustment of measured values (measured value of block size of 16) performed in the histogram analysis section;

FIG. 13 is a block diagram showing an example of the configuration of a block noise reduction unit that forms the video signal processing apparatus;

FIG. 14 is a flowchart showing an example of filter selection performed by a block noise reduction filter selection section; and

FIG. 15 is a flowchart showing another example of filter selection performed by the block noise reduction filter selection section.

### DETAILED DESCRIPTION

A mode for carrying out the present disclosure (hereinafter referred to as “embodiment”) will be described below. The description will be made in the following orders.

1. Embodiment

2. Variation

### 1. Embodiment

[Example of Configuration of Video Signal Processing Apparatus]

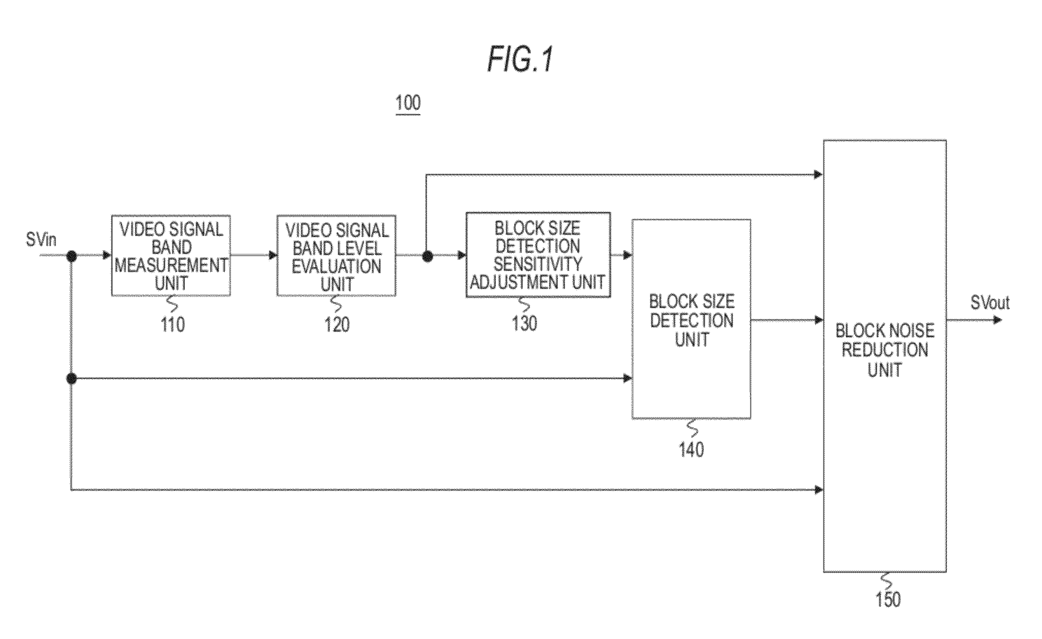

FIG. 1 shows an example of the configuration of a video signal processing apparatus 100 as an embodiment. The video signal processing apparatus 100 reduces the amount of block noise contained in a video signal. The video signal processing apparatus 100 includes a video signal band measurement unit 110, a video signal band level evaluation unit 120, a block size detection sensitivity adjustment unit 130, a block size detection unit 140, and a block noise reduction unit 150.

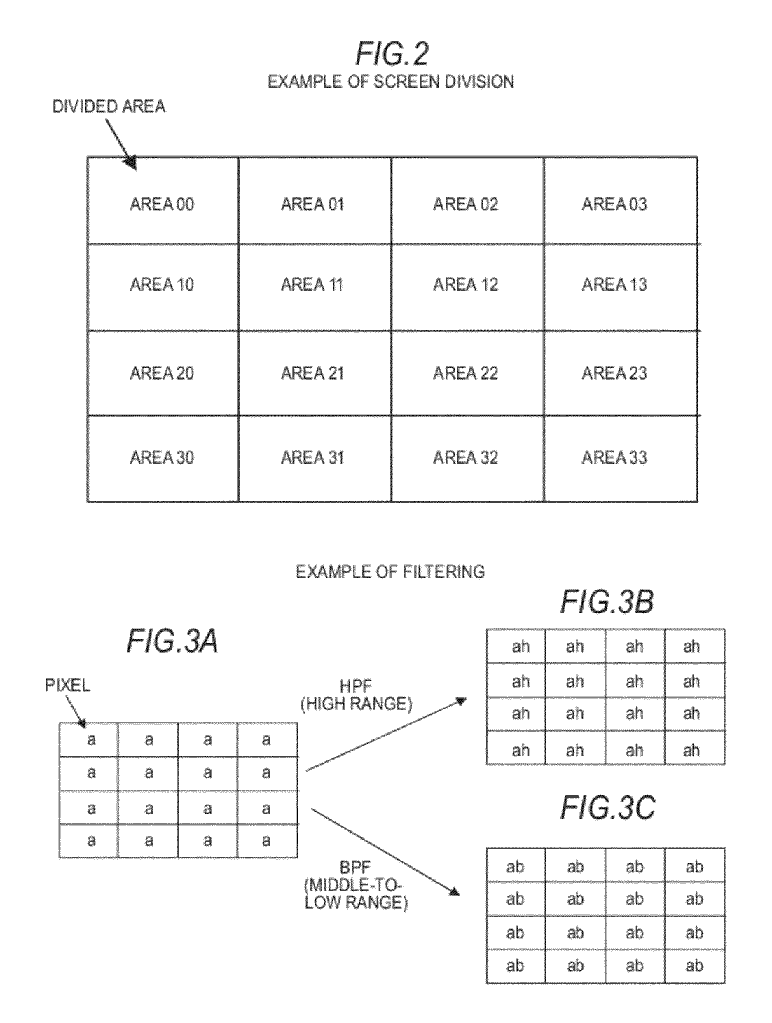

The video signal band measurement unit 110 measures a signal band of an input video signal SVin. The video signal band measurement unit 110 measures the signal band of the input video signal SVin for each area obtained by dividing a screen into a predetermined (arbitrary) number of areas. FIG. 2 shows an example in which the screen is divided into 16 areas, that is, 16 divided areas from a region 00 to a region 33.

The video signal band measurement unit 110 uses a predetermined number (arbitrary number) of filters to extract signal components of the predetermined number of bands from the video signal SVin. FIGS. 3A to 3C show an example of filtering using two filters, an HPF (high-pass filter) and a BPF (band-pass filter). FIG. 3A shows pixels “a” before an area to be processed undergoes the filtering. It is noted that the number of pixels contained in the area is 16 for ease of description.

FIG. 3B shows pixels “ah” obtained, for example, by performing horizontal HPF filtering on the pre-filtered pixels “a”. The HPF filtering extracts a high-range signal component from the video signal SVin. FIG. 3C shows pixels “ab” obtained, for example, by performing horizontal BPF filtering on the pre-filtered pixels “a”. The BPF filtering extracts a middle-to-low-range signal component from the video signal SVin. Each of the filters is formed, for example, of an FIR (finite impulse response) filter.

The video signal band measurement unit 110 provides a measured signal band of the input video signal SVin for each of the divided areas based on the signal component of the band extracted through each of the filters. The video signal band measurement unit 110 first uses the filtered values obtained through each of the filters to obtain a measured value for the filter. The video signal band measurement unit 110 obtains a measured value for each of the filters by using any of the following methods (1) to (3).

(1) Raise the filtered value for each pixel to the N-th power (N is a natural number) or multiply the filtered value for each pixel by a coefficient, and sum the resultant values.

(2) Check the filtered value for each pixel and sum pixel values greater than a threshold.

(3) Check the filtered value for each pixel and sum differences between pixel values greater than a threshold and the threshold.

The video signal band measurement unit 110 then determines a measured signal band of the input video signal SVin based on the measured value for each of the filters. The video signal band measurement unit 110 multiplies the measured value for each of the filters by a coefficient according to the characteristics of the filter and determines a measured signal band of the input video signal SVin by using any of the following methods (1) to (3).

(1) From the measured values obtained from the filters and multiplied by the coefficients according thereto, extract the greatest and smallest multiplied values, and calculate the ratio therebetween as a measured signal band of the input video signal SVin. For example, let F1, F2, . . . , FN be measured values obtained from N (N is an integer greater than or equal to two) filters, and let F1*S1, F2*S2, . . . , FN*SN be the measured values F1, F2, . . . , FN multiplied by coefficients S1, S2, . . . , SN. Among F1*S1, F2*S2, . . . , FN*SN, the greatest value is called F*Smax, and the smallest value is called F*Smin. A measured band BS is determined by the following expression: BS=F*Smax/F*Smin.

For example, consider the filtering using the two filters, HPF and BPF, described above. Let Fh and Fb be measured values obtained from the two filters, and let Sh and Sb be coefficients according to the characteristics of the filters. The measured band BS is determined by the following expression: BS=Fb*Sb/Fh*Sh. In this case, Sh=1 and Sb=4, for example.

(2) The sum of the measured values obtained from the filters and multiplied by the coefficients according thereto is used as the measured signal band of the input video signal SVin. For example, let F1, F2, . . . , FN be measured values obtained from N (N is an integer greater or equal to than two) filters, and let F1*S1, F2*S2, . . . , FN*SN be the measured values F1, F2, . . . , FN multiplied by coefficients S1, S2, . . . , SN. The measured band BS is determined by the following expression: BS=F1*S1+F2*S2+. . .+FN*SN.

(3) The average of the measured values obtained from the filters and multiplied by the coefficients according thereto is used as the measured signal band of the input video signal SVin. For example, let F1, F2, . . . , FN be measured values obtained from N (N is an integer greater than or equal to two) filters, and let F1*S1, F2*S2, . . . , FN*SN be the measured values F1, F2, . . . , FN multiplied by coefficients S1, S2, . . . , SN. The measured band BS is determined by the following expression: BS=(F1*S1+F2*S2+. . . +FN*SN)/N.

The video signal band level evaluation unit 120 evaluates a band level of the resultant signal band measured by the video signal band measurement unit 110. The video signal band measurement unit 110 measures the signal band of the input video signal SVin for each of the divided areas obtained by dividing the screen into a predetermined number of areas, as described above.

The video signal band level evaluation unit 120 first evaluates the band level for each of the divided areas based on the measured band for the divided area. The video signal band level evaluation unit 120 evaluates the band level for each of the divided areas and relates the band level to one of a predetermined number of levels, for example, levels 1 to 10, based on thresholds unique to the band levels.

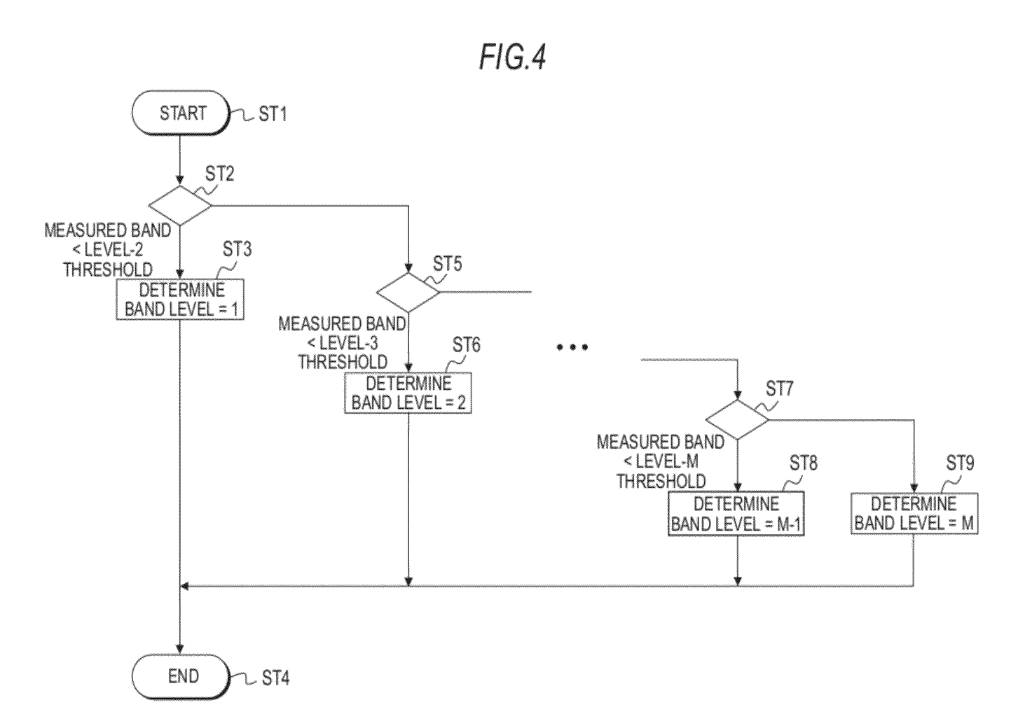

FIG. 4 is a flowchart showing an example of the band level evaluation performed in the video signal band level evaluation unit 120. In the example, the band level is evaluated and related to one of levels 1 to M (M is an integer greater than or equal to two). The video signal band level evaluation unit 120 starts the evaluation in step ST1 and then carries out the process in step ST2.

The video signal band level evaluation unit 120 determines in step ST2 whether or not a measured band is smaller than a level-2 threshold. When the measured band is smaller than the level-2 threshold, the video signal band level evaluation unit 120 determines that the band level is evaluated to be 1 and then terminates the evaluation in step ST4.

When the measured band is greater than or equal to the level-2 threshold in step ST2, the video signal band level evaluation unit 120 carries out the process in step ST5. The video signal band level evaluation unit 120 determines in step ST5 whether or not the measured band is smaller than a level-3 threshold. When the measured band is smaller than the level-3 threshold, the video signal band level evaluation unit 120 determines that the band level is evaluated to be 2 in step ST6 and then terminates the evaluation in step ST4.

When the measured band is greater than or equal to the level-3 threshold in step ST5, the video signal band level evaluation unit 120 carries out a process of determining whether the measured band is evaluated to be greater than or equal to the level-3 threshold. The same processes described above are repeated in the following steps. In the flowchart of FIG. 4, the video signal band level evaluation unit 120 determines in step ST7 whether or not the measured band is evaluated to be smaller than a level-M threshold.

When the measured band is smaller than the level-M threshold, the video signal band level evaluation unit 120 determines that the band level is evaluated to be M-1 in step ST8 and then terminates the evaluation in step ST4. On the other hand, when the measured band is greater than or equal to the level-M threshold in step ST7, the video signal band level evaluation unit 120 determines that the band level is evaluated to be M in step ST9 and then terminates the evaluation in step ST4.

The video signal band level evaluation unit 120 then calculates the band level of the entire screen based on the band level evaluated for each of the divided areas. The video signal band level evaluation unit 120 determines the band level of the entire screen, for example, by using any of the following methods (1) to (3).

(1) Calculate the average of the band levels of the divided areas and use the average as the band level of the entire screen.

(2) Among the band levels of the divided areas, select the highest band level or the lowest band level and use the selected band level as the band level of the entire screen.

(3) Among the band levels of the divided areas, calculate the average of a predetermined number of highest band levels or the average of a predetermined number of lowest band levels and use the calculated band level as the band level of the entire screen.

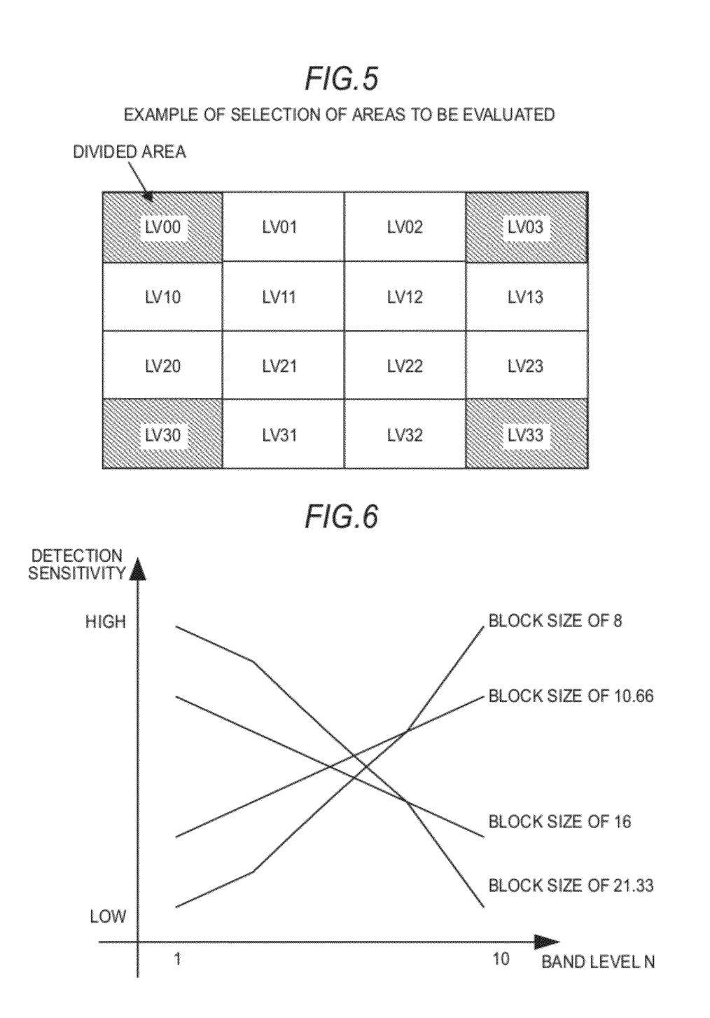

The video signal band level evaluation unit 120, when calculating the band level of the entire screen based on the band level evaluated for each of the divided areas, can use any divided area for the calculation. In this way, the evaluation of the band level of the entire screen will not be affected, for example, by the band level of a divided area containing a black strip portion where substantially no video signal is present or the band level of a divided area in the periphery, for example, at a corner where the amount of important information on a video signal is small, whereby the band level of the entire screen can be evaluated more precisely. FIG. 5 shows a case where the screen is divided into 16 areas and the signal band is measured for each of the areas except the divided areas at the four corners. LV00 to LV33 represent evaluated levels of the respective divided areas.

Further, the video signal band level evaluation unit 120 performs the band level evaluation described above for each frame (field), and band levels evaluated in the current frame (field) and a predetermined number (L) of past frames (fields) are averaged. The average is then used as a final evaluated band level. Averaging band levels evaluated not only in the current frame but also in a predetermined number of past frames prevents a final band level from varying due to partial change in a video signal and allows the final band level to be stably evaluated. When L=0, the evaluation in the current frame provides a final band level.

The block size detection sensitivity adjustment unit 130 adjusts block size detection sensitivities in block size detection based on the band level of the entire screen evaluated by the video signal band level evaluation unit 120. For example, consider now a case where the block sizes to be detected are “8”, “10.66”, “16”, and “21.33”, and evaluated band levels range from 1 (low quality) to 10 (high quality). In this case, the block size detection sensitivity adjustment unit 130 adjusts the block size detection sensitivities as follows, for example, by referring to the relationship between the band level and the detection sensitivity shown in FIG. 6.

When the band level is 1,
the detection sensitivity to a block size of 8→low,
the detection sensitivity to a block size of 10.66→relatively low,
the detection sensitivity to a block size of 16→relatively high, and
the detection sensitivity to a block size of 21.33→high.

When the band level is 10,
the detection sensitivity to a block size of 8→high,
the detection sensitivity to a block size of 10.66→relatively high,
the detection sensitivity to a block size of 16→relatively low, and
the detection sensitivity to a block size of 21.33→low.

The adjustment of the detection sensitivity described above is presented by way of example, and the detection sensitivity may arbitrarily be adjusted. For example, when the band level is 1, the block size of 8 may not be detected. Further, when the block sizes to be detected are not 8, 10.66, 16, or 21.33, the detection sensitivity is similarly adjusted. That is, the block size detection sensitivity adjustment unit 130 performs the adjustment in such a way that the detection sensitivity to a small block size is set at a high value when the band level is high.

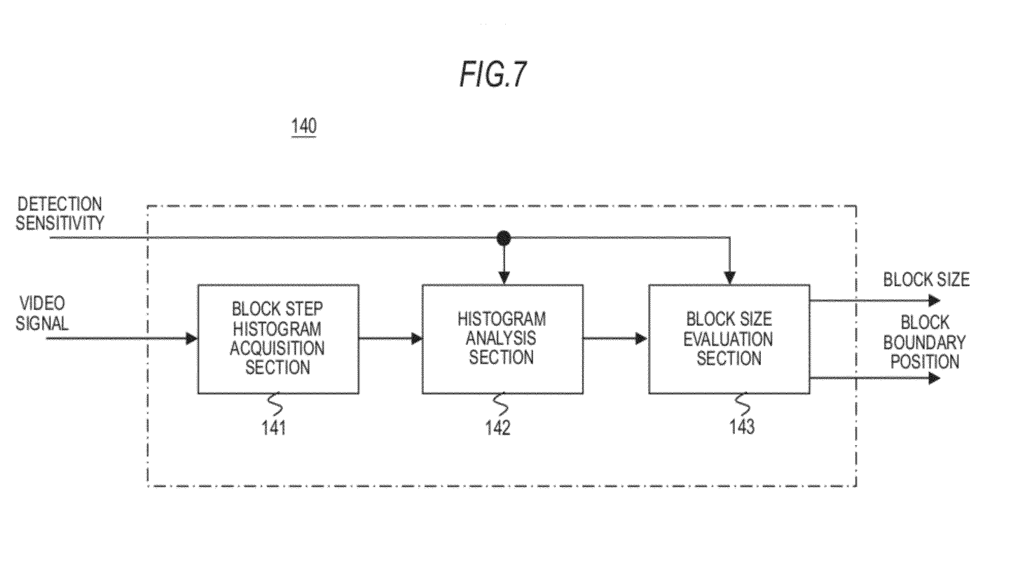

The block size detection unit 140 detects the block sizes of blocks in the input video single SVin by using the block size detection sensitivities adjusted by the block size detection sensitivity adjustment unit 130. FIG. 7 shows an example of the configuration of the block size detection unit 140. The block size detection unit 140 includes a block step histogram acquisition section 141, a histogram analysis section 142, and a block size evaluation section 143.

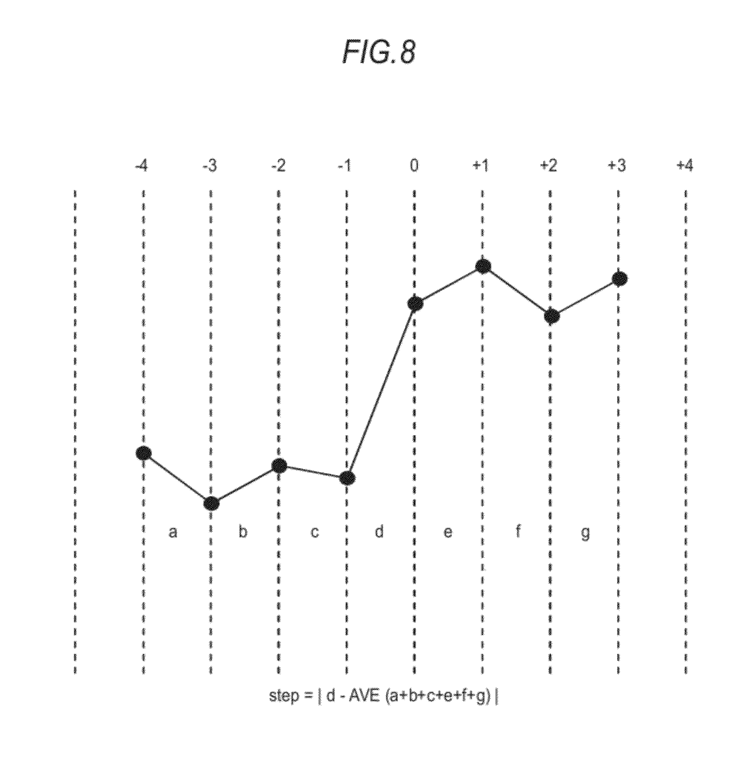

The block step histogram acquisition section 141 determines whether or not there is a block step for each of a predetermined number of pixels based on the input video signal SVin and creates a histogram of the results having been determined to be block steps. The block step histogram acquisition section 141 first calculates “step” based on a step “d” at a point of interest and the average of steps therearound by using the following equation (1), as shown in FIG. 8. FIG. 8 shows an example in which a block step is evaluated for each pixel.

step=|d-AVE(a+b+c+e+f+g)| (1)

In Equation (1), values “a” to “g” represent absolute differences between adjacent pixels, and AVE represents the average of the absolute differences between pixels around the pixel of interest.

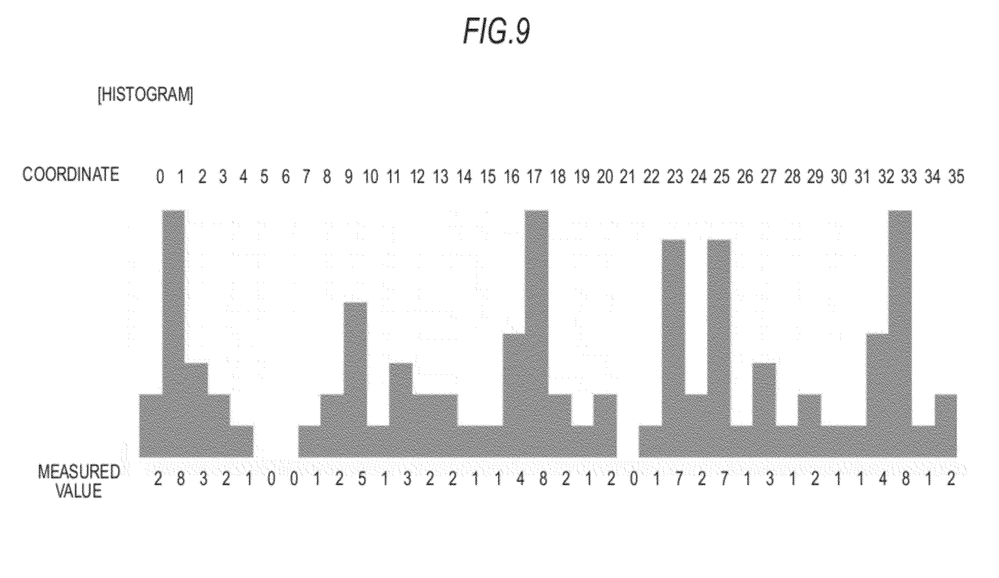

The block step histogram acquisition section 141 then determines that there is a block step when the following expression is satisfied: threshold A<step<threshold B, and creates a histogram of the results having been determined to be block steps. FIG. 9 shows 36 histogram data strings as an example. The thresholds A and B are set in advance. The thresholds A and B may be set in accordance with the band level evaluated by the video signal band level evaluation unit 120 described above. For example, when the band level is low, in which case a block step does not tend to be produced, a block step is readily found by lowering the threshold A and raising or lowering the threshold B. When the band level is high, the threshold A is raised and the threshold B is lowered or raised so that those that are not block steps are not determined to be block steps.

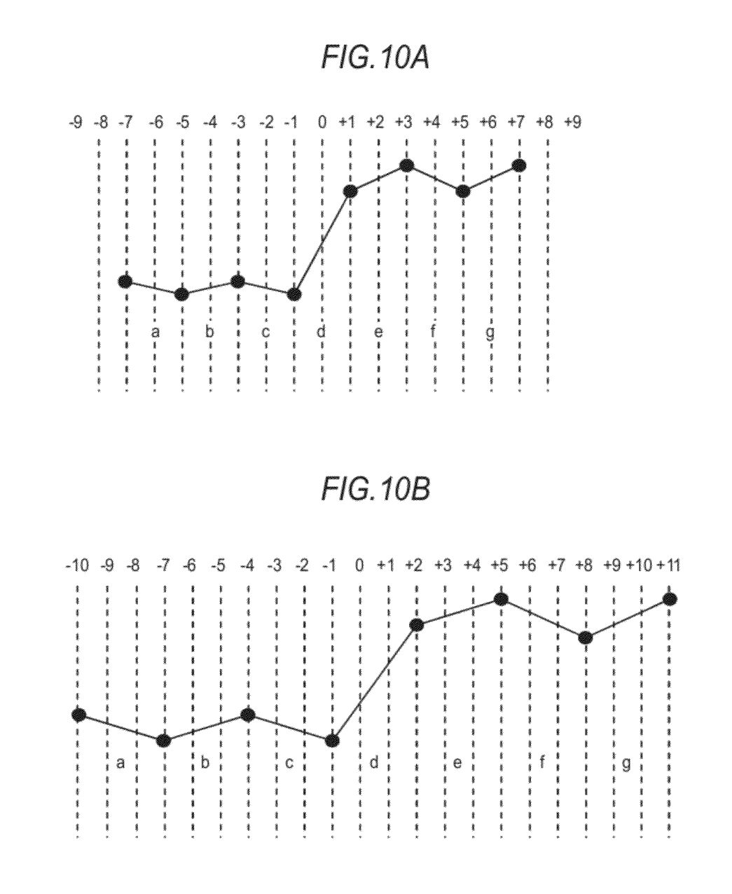

The above description has been made with reference to the case where it is determined whether or not there is a block step for each pixel. Alternatively, it may be determined whether or not there is a block step by calculating “step” based on the step “d” at a point of interest and the average of steps therearound for every two pixels as shown in FIG. 10A or for every three pixels as shown in FIG. 10B.

The histogram analysis section 142 performs sensitivity adjustment by multiplying measured values of each of the block sizes in the histogram acquired by the block step histogram acquisition section 141 by an adjustment coefficient set in advance in accordance with the detection sensitivity to the block size. A description will be made with reference to, for example, the block size of 8 (coordinates 1, 9, 17, 25, and 33) and the block size of 16 (coordinates 1, 17, and 33) in the histogram data shown in FIG. 9 described above.

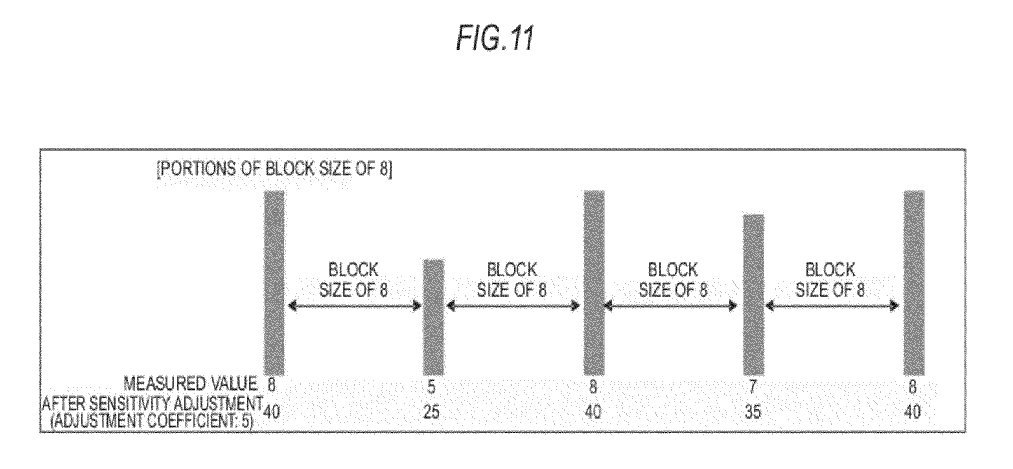

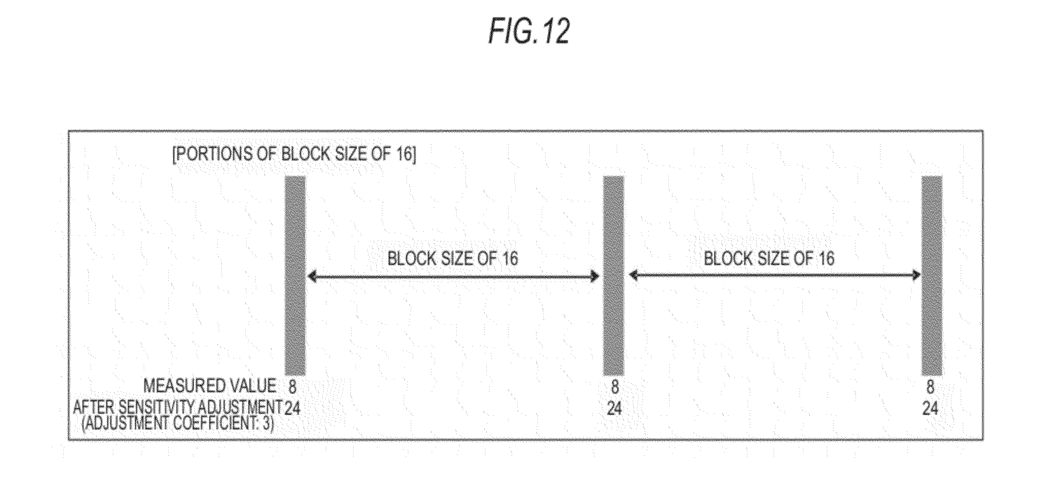

The detection sensitivity to the block size of 8 is slightly high and the adjustment coefficient is set at 5, whereas the detection sensitivity to the block size of 16 is slightly low and the adjustment coefficient is set at 3. In this case, the measured values of the block size of 8 are adjusted by multiplying them by the adjustment coefficient of 5, as shown in FIG. 11. Further, in this case, the measured values of the block size of 16 are adjusted by multiplying them by the adjustment coefficient of 3, as shown in FIG. 12.

The block size evaluation section 143 multiplies the average of the measured values of each of the block sizes having undergone the sensitivity adjustment in the histogram analysis section 142 by a correction coefficient set in advance in accordance with the detection sensitivity to the block size and evaluates the block size based on the corrected block size. The block size evaluation section 143 first determines the average of the measured values of each of the block sizes having undergone the sensitivity adjustment. For example, the measured block sizes of 8 shown in FIG. 11 average out to (40+25+40+35+40)/5=36, and the measured block sizes of 16 shown in FIG. 12 average out to (24+24+24)/3=24.

The block size evaluation section 143 then multiplies the calculated average of the measured values of each of the block sizes having undergone the sensitivity adjustment by a correction coefficient according to the detection sensitivity. The detection sensitivity to the block size of 8 is slightly high and the correction coefficient is set at 1.5, whereas the detection sensitivity to the block size of 16 is slightly low and the correction coefficient is set at 0.75. In this case, the averaged measured value of the block size of 8 is multiplied by the correction coefficient of 1.5, resulting in 36×1.5=54. Further, in this case, the averaged measured value of the block size of 16 is multiplied by the correction coefficient of 0.75, resulting in 24×0.75=18.

The block size evaluation section 143 then evaluates the block size based on the averaged measured value of each of the block sizes having undergone the correction. In this case, the block size evaluation section 143 sets, for example, the greatest corrected block size as a final block size. In the example of the block sizes of 8 and 16 described above, in which the corrected block sizes of 8 and 16 are 54 and 18 respectively, the block size evaluation section 143 determines that the block size of 8 is the final block size.

The block size detection unit 140 detects horizontal and vertical block sizes by performing the processes described above in the horizontal and vertical directions. Although no detailed description will be made, the block size evaluation section 143 outputs information on block boundary position as well as information on block size.

Referring back to FIG. 1, the block noise reduction unit 150 reduces the amount of block noise contained in the input video signal SVin based on the block sizes detected by the block size detection unit 140 and provides an output video signal SVout. The block noise reduction unit 150 reduces the amount of block noise by applying block noise reduction filtering (LPF) for smoothing to the pixels in the positions along the boundaries between the blocks having the detected block sizes.

A block noise reduction filter used in the block noise reduction unit 150 is selected based on the band level evaluated by the video signal band level evaluation unit 120 described above. In this case, for example, when the band level is high, a block noise reduction filter having weakened low-pass filter characteristics is selected. In this way, the amount of block noise can be effectively reduced without any degradation of the video signal.

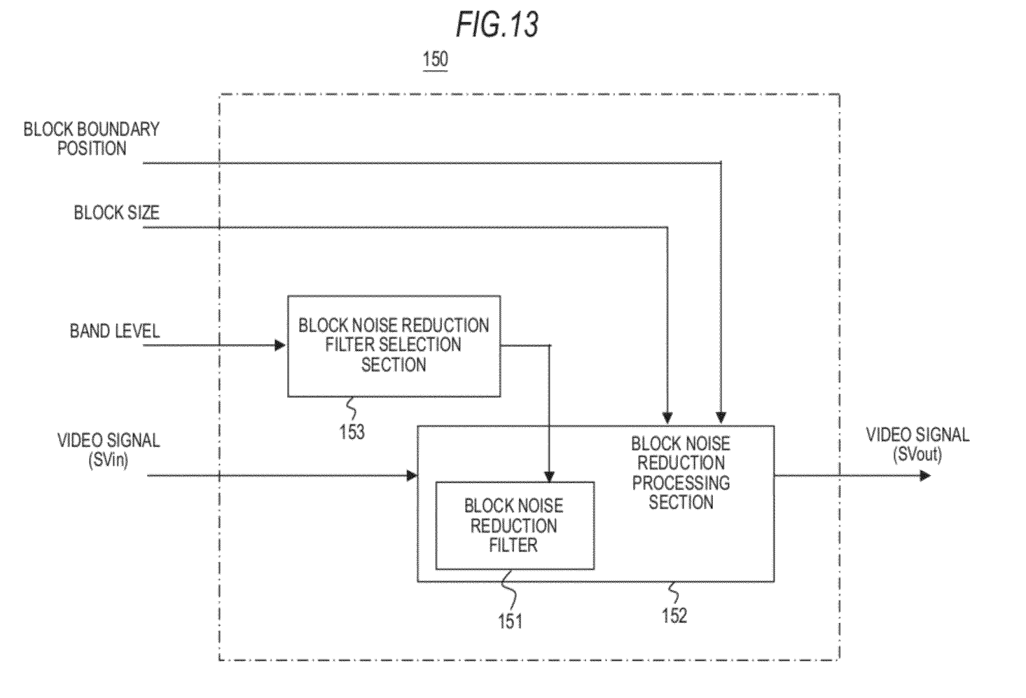

FIG. 13 shows an example of the configuration of the block noise reduction unit 150. The block noise reduction unit 150 includes a block noise reduction processing section 152 having a block noise reduction filter 151 and a block noise reduction filter selection section 153. The block noise reduction processing section 152 reduces the amount of block noise by applying, based on the information on block size and block boundary position from the block size detection unit 140, block noise reduction filtering for smoothing performed by the block noise reduction filter (LPF) 151 to the pixels in the positions along the boundaries between the blocks having the block sizes.

The block noise reduction filter selection section 153 selects the block noise reduction filter 151 used in the block noise reduction processing section 152 based on the information on band level from the video signal band level evaluation unit 120. Specifically, the block noise reduction filter selection section 153 selects a block noise reduction filter having weakened low-pass filter characteristics as the block noise reduction filter 151 when the band level is high.

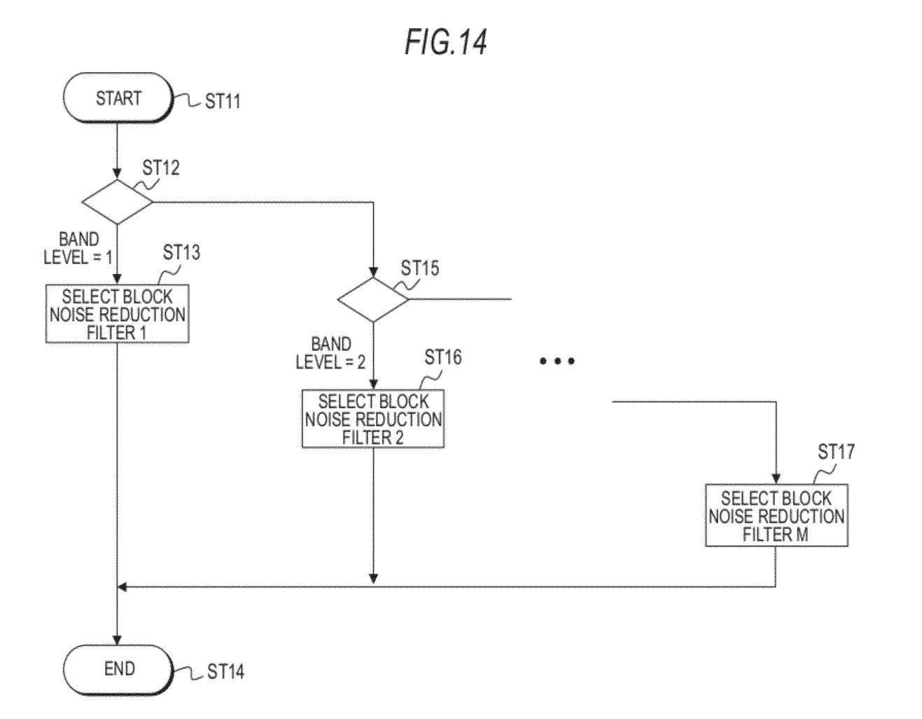

The flowchart of FIG. 14 shows an example of the filter selection performed by the block noise reduction filter selection section 153. In the example, a block noise reduction filter corresponding to one of the band levels 1 to M is selected. The block noise reduction filter selection section 153 performs the filter selection for each frame.

The block noise reduction filter selection section 153 starts the selection in step ST11 and then carries out the process in step ST12. The block noise reduction filter selection section 153 determines in step ST12 whether or not the band level is 1. When the band level is 1, the block noise reduction filter selection section 153 selects a block noise reduction filter 1 in step ST13 and then terminates the selection in step ST14.

When the band level is not 1 in step ST12, the block noise reduction filter selection section 153 carries out the process in step ST15. The block noise reduction filter selection section 153 determines in step ST15 whether or not the band level is 2. When the band level is 2, the block noise reduction filter selection section 153 selects a block noise reduction filter 2 in step ST16 and then terminates the selection in step ST14.

When the band level is not 2 in step ST15, the block noise reduction filter selection section 153 selects a filter corresponding to one of the band levels greater than or equal to 3. In the following steps, the same processes described above are repeated. As the final step, when the band level is not M-1, the block noise reduction filter selection section 153 selects a block noise reduction filter M in step ST17 and then terminates the selection in step ST14.

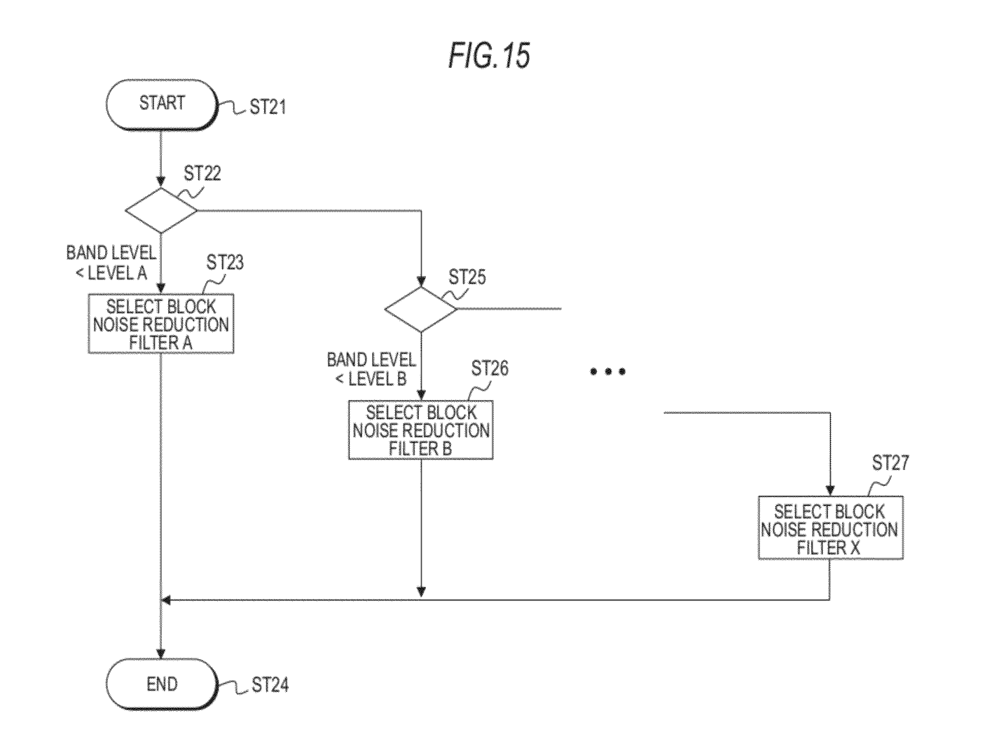

The flowchart shown in FIG. 15 shows another example of the filter selection performed by the block noise reduction filter selection section 153. In the example, a common filter is selected when the band level falls within a certain range. The block noise reduction filter selection section 153 performs the filter selection for each frame.

The block noise reduction filter selection section 153 starts the selection in step ST21 and then carries out the process in step ST22. The block noise reduction filter selection section 153 determines in step ST22 whether or not the band level is smaller than a level A. When the band level is smaller than the level A, the block noise reduction filter selection section 153 selects a block noise reduction filter A in step ST23 and then terminates the selection in step ST24.

When the band level is greater than or equal to the level A in step ST22, the block noise reduction filter selection section 153 carries out the process in step ST25. The block noise reduction filter selection section 153 determines in step ST25 whether or not the band level is smaller than a level B. When the band level is smaller than the level B, the block noise reduction filter selection section 153 selects a block noise reduction filter B in step ST26 and then terminates the selection in step ST24.

When the band level is greater than or equal to the level B in step ST25, the block noise reduction filter selection section 153 selects a filter corresponding to a band level greater than or equal to the level B. In the following steps, the same processes described above are repeated. When the band level falls within the last range, the block noise reduction filter selection section 153 selects a block noise reduction filter X in step ST27 and then terminates the selection in step ST24.

In the selection in the flowchart shown in FIG. 15, for example, when the evaluated band levels range from 1 to 10 and the noise reduction filter is selected from filters A, B, C, and D, the filter selection is performed as follows: That is, when the band level is any of 1 to 3, the filter A is selected; when the band level is 4 or 5, the filter B is selected; when the band level is 6, the filter C is selected; and when the band level is any of 7 to 10, the filter D is selected.

The operation of the video signal processing apparatus shown in FIG. 1 will be briefly described. The input video signal SVin is supplied to the video signal band measurement unit 110, the block size detection unit 140, and the block noise reduction unit 150. The video signal band measurement unit 110 measures the signal band of the input video signal SVin. In this case, the signal band of the input video signal SVin is measured for each of the divided areas obtained by dividing the screen into a predetermined number (arbitrary number) of areas.

In this case, the video signal band measurement unit 110 uses a predetermined number (arbitrary number) of filters to extract signal components of the predetermined number of bands from the input video signal SVin. The video signal band measurement unit 110 then provides a measured signal band of the input video signal SVin for each of the divided areas based on the signal component of the band extracted through each of the filters. The video signal band measurement unit 110 then determines a measured signal band of the input video signal SVin based on the measured value for each of the filters.

The measured signal band for each of the divided areas provided by the video signal band measurement unit 110 is supplied to the video signal band level evaluation unit 120. The video signal band level evaluation unit 120 evaluates the band level of the resultant signal band measured by the video signal band measurement unit 110 for each of the divided areas.

In this case, the video signal band level evaluation unit 120 evaluates the band level for each of the divided areas based on the measured band for the divided area. The video signal band level evaluation unit 120 then calculates the band level of the entire screen based on the band level evaluated for each of the divided areas. The video signal band level evaluation unit 120 can use any divided area to be used for the calculation. Further, the video signal band level evaluation unit 120 performs the band level evaluation for each frame, and band levels evaluated in the current frame and a predetermined number of past frames are averaged. The average is then used as the final evaluated band level.

The band level of the entire screen evaluated by the video signal band level evaluation unit 120 is supplied to the block size detection sensitivity adjustment unit 130 and the block noise reduction unit 150. The block size detection sensitivity adjustment unit 130 adjusts the block size detection sensitivities in the block size detection based on the band level of the entire screen. In this case, the block size detection sensitivity adjustment unit 130 performs the adjustment in such a way that the detection sensitivity to a small block size is set at a high value when the band level is high (see FIG. 6).

The block size detection sensitivities adjusted by the block size detection sensitivity adjustment unit 130 are supplied to the block size detection unit 140. The block size detection unit 140 detects the block sizes of blocks in the input video signal SVin by using the block size detection sensitivities.

In this case, the block step histogram acquisition section 141 determines whether or not there is a block step for each of a predetermined number of pixels based on the input video signal SVin and creates a histogram of the results having been determined to be block steps. The histogram analysis section 142 performs sensitivity adjustment by multiplying measured values of each of the block sizes in the histogram acquired by the block step histogram acquisition section 141 by an adjustment coefficient set in advance in accordance with the detection sensitivity to the block size.

The block size evaluation section 143 multiplies the average of the measured values of each of the block sizes having undergone the sensitivity adjustment in the histogram analysis section 142 by a correction coefficient set in advance in accordance with the detection sensitivity to the block size and evaluates the block size based on the corrected block size. In this case, the block size evaluation section 143 sets, for example, the greatest corrected block size as the final block size.

The information on block size and block boundary position detected by the block size detection unit 140 is supplied to the block noise reduction unit 150. The block noise reduction unit 150 reduces the amount of block noise contained in the input video signal SVin based on the detected block sizes and provides an output video signal SVout. The block noise reduction unit 150 reduces the amount of block noise by applying block noise reduction filtering (LPF) for smoothing to the pixels in the positions along the boundaries between the blocks having the detected block sizes.

In this case, the block noise reduction filter used in the block noise reduction unit 150 is selected based on the band level evaluated by the video signal band level evaluation unit 120 described above. For example, when the band level is high, a block noise reduction filter having weakened low-pass filter characteristics is selected.

As described above, the video signal processing apparatus 100 shown in FIG. 1 measures the signal band of the input video signal SVin and evaluates the band level. The block size detection sensitivity adjustment unit 130 then adjusts the block size detection sensitivities based on the evaluated band level in such a way that the detection sensitivity to a small block size is set at a high value when the band lever is high. The block size detection unit 140 then detects block sizes by using the adjusted block size detection sensitivities. The block size detection unit 140 can therefore precisely detect the block sizes.

Further, in the video signal processing apparatus 100 shown in FIG. 1, the block noise reduction unit 150 reduces the amount of block noise contained in the input video signal SVin by applying block noise reduction filtering (LPF) for smoothing to the pixels in the positions along the boundaries between the blocks having the detected block sizes. In this process, as the block noise reduction filter used in the block noise reduction unit 150, a block noise reduction filter having weakened low-pass filter characteristics is selected when the band level is high based on the band level evaluated by the video signal band level evaluation unit 120. As a result, the amount of block noise can be effectively reduced without any degradation of the video signal.

### 2. Variation

Although not described above, not only can the video signal processing apparatus 100 shown in FIG. 1 be formed of hardware, but also software (program) can instruct a computer to function as the functional blocks of the video signal processing apparatus 100.

The present disclosure is applicable, for example, to a video signal processing apparatus that is built in a television receiver and reduces the amount of block noise contained in a decoded video signal (image data).

It should be understood by those skilled in the art that various modifications, combinations, sub-combinations and alterations may occur depending on design requirements and other factors insofar as they are within the scope of the appended claims or the equivalents thereof.

What is claimed is:

1. A video signal processing apparatus comprising:
a video signal band measurement unit that measures a signal band of an input video signal;
a band level evaluation unit that evaluates a band level of the resultant signal band measured by the video signal band measurement unit;
a block size detection sensitivity adjustment unit that adjusts block size detection sensitivities in block size detection based on the band level evaluated by the band level evaluation unit; and
a block size detection unit that detects the block sizes of blocks in the input video signal by using the block size detection sensitivities adjusted by the block size detection sensitivity adjustment unit.

2. The video signal processing apparatus according to claim 1,
wherein the video signal band measurement unit not only performs filtering by which signal components of a predetermined number of bands are extracted from the input video signal but also provides a measured signal band of the input video signal based on the signal components of the predetermined number of bands.

3. The video signal processing apparatus according to claim 1,
wherein the video signal band measurement unit measures the signal band of the input video signal for each divided area obtained by dividing a screen into a predetermined number of areas, and
the band level evaluation unit not only evaluates the band level for each of the divided areas based on the measured value of the divided area measured by the video signal band measurement unit but also evaluates the band level of the entire screen based on all or part of the band levels evaluated for the divided areas.

4. The video signal processing apparatus according to claim 1,
wherein the band level evaluation unit evaluates the band level and relates the band level to one of a predetermined number of levels.

5. The video signal processing apparatus according to claim 1,
wherein the band level evaluation unit averages band levels evaluated in a current frame and a predetermined number of past frames and uses the average as a final evaluated band level.

6. The video signal processing apparatus according to claim 1,
wherein the block size detection unit includes a block step histogram acquisition section that determines whether or not there is a block step for each of a predetermined number of pixels based on the input video signal and creates a histogram of the results having been determined to be block steps,
a histogram analysis section that performs sensitivity adjustment by multiplying measured values of each of the block sizes in the histogram acquired by the block step histogram acquisition section by an adjustment coefficient set in accordance with the detection sensitivity to the block size, and
a block size evaluation section that multiplies the average of the measured values of each of the block sizes having undergone the sensitivity adjustment in the histogram analysis section by a correction coefficient set in accordance with the detection sensitivity to the block size and evaluates the block size based on the corrected block size.

7. A video signal processing method comprising:
measuring a signal band of an input video signal;
evaluating a band level of the resultant signal band measured in the measuring;
adjusting block size detection sensitivities in block size detection based on the band level evaluated in the evaluating; and
detecting the block sizes of blocks in the input video signal by using the block size detection sensitivities adjusted in the adjusting.

8. A program that instructs a computer to function as:
video signal band measurement means for measuring a signal band of an input video signal;
band level evaluation means for evaluating a band level of the resultant signal band measured by the video signal band measurement means;
block size detection sensitivity adjustment means for adjusting block size detection sensitivities in block size detection based on the band level evaluated by the band level evaluation means; and
block size detection means for detecting the block sizes of blocks in the input video signal by using the block size detection sensitivities adjusted by the block size detection sensitivity adjustment means.

9. A video signal processing apparatus comprising:
a block size detection unit that detects block sizes of blocks in an input video signal;
a block noise reduction unit that reduces the amount of block noise contained in the input video signal based on the block sizes detected by the block size detection unit;
a video signal band measurement unit that measures a signal band of the input video signal; and
a band level evaluation unit that evaluates a band level of the resultant signal band measured by the video signal band measurement unit,
wherein a block noise reduction filter used in the block noise reduction unit is selected based on the band level evaluated by the band level evaluation unit.

10. The video signal processing apparatus according to claim 9,
further comprising a block size detection sensitivity adjustment unit that adjusts block size detection sensitivities in block size detection based on the band level evaluated by the band level evaluation unit,
wherein the block size detection unit detects the block sizes of blocks in the input video signal by using the block size detection sensitivities adjusted by the block size detection sensitivity adjustment unit.
